(19) United States
(12) Patent Application Publication
(10) Pub. No.: US 2025/0078043 A1
(43) Pub. Date: Mar. 6, 2025

(54) RECYCLING SYSTEMS AND METHODS

(71) Applicant: Leigh Ashlin, Melbourne (AU)

(72) Inventor: Leigh Ashlin, Melbourne (AU)

(73) Assignee: Simbl ESG Pty Ltd, Truganina (AU)

(21) Appl. No.: 18/722,319

(22) PCT Filed: Dec. 19, 2022
(86) PCT No.: PCT/AU2022/051533

§ 371 Date: Jun. 20, 2024

(30) Foreign Application Priority Data
Dec. 21, 2021 (AU) 2021904170

(51) Int. Cl. G06Q 10/30; G06K 7/14

(52) U.S. Cl. CPC G06Q 10/30; G06K 7/1417

(57) ABSTRACT

Various waste recycling methods and systems are provided that incentivise sorting of waste for recycling. One such method comprises: scanning, using a portable computing device, a code or symbol of an item of waste, the code or symbol identifying a type of the item of waste; scanning, using the portable computing device, a code or symbol associated with a recycling reservoir and a particular type of waste; determining, a match between the type of the item of waste and the type of waste associated with the recycling reservoir; and executing, upon determining the match, a smart contract, the smart contract allocating one or more tokens to an account associated with the portable computing device according to the match.

### TECHNICAL FIELD

The present invention relates to recycling. In particular, the present invention relates to systems and methods for incentivising, rewarding and/or simplifying recycling.

### BACKGROUND ART

The amount of waste being generated across the world is ever increasing, and a significant amount of this waste is not recycled. This has significant negative environmental impact, which is clearly undesirable.

It is estimated that the world's largest fast food restaurant chain alone produces over 400 million recyclable items per day, a significant portion of which is not recycled. Similarly, it is estimated that over 630 billion plastic drink bottles, over 18 billion aluminium cans, and over 400 billion single-use coffee cups are manufactured each year, a significant portion of which is not recycled.

One problem with recycling waste is that waste producers often have little or no motivation to be involved in the recycling of the waste that they create. Even those that actively promote recycling have difficulty quantifying their recycling impact in a transparent manner, particularly for very large waste producers.

Similarly, not all individuals have sufficient motivation to sort waste into waste recycling bins, to simplify recycling of the waste. This is particularly the case when away from home.

Another problem with recycling is that waste is often mixed, such that various different types of recyclable products are mixed together, potentially with non-recyclable products. Sorting is very time consuming and costly, and as waste producers have no motivation or requirement to contribute to the sorting of their waste, in many cases waste sorting is never performed, and recyclable products enter landfill.

As such, there is clearly a need for improved recycling methods and systems.

It will be clearly understood that, if a prior art publication is referred to herein, this reference does not constitute an admission that the publication forms part of the common general knowledge in the art in Australia or in any other country.

### SUMMARY OF INVENTION

The present invention relates to recycling methods and systems, which may at least partially overcome at least one of the abovementioned disadvantages or provide the consumer with a useful or commercial choice.

With the foregoing in view, the present invention in one form, resides broadly in a waste recycling method comprising:
scanning, using a portable computing device, a code or symbol of an item of waste, the code or symbol identifying a type of the item of waste;
scanning, using the portable computing device, a code or symbol associated with a recycling reservoir and a particular type of waste;
determining, a match between the type of the item of waste and the type of waste associated with the recycling reservoir; and executing, upon determining the match, a smart contract, the smart contract allocating one or more tokens to an account associated with the portable computing device according to the match.

Advantageously, the method incentivizes recycling by providing one or more tokens to an account when an item is matched to an appropriate recycling reservoir. As smart contracts are used, commitment is provided prior to the recycling taking place.

Preferably, the smart contract is defined on a blockchain or distributed ledger. Preferably, the smart contract is executed remotely to the portable computing device.

Preferably, each type (class) of waste is associated with a different smart contract.

Preferably, the item of waste comprises a single use item, such as a plastic bottle or aluminium can.

Preferably, the code or symbol on the item of waste is scanned using a camera of the portable computing device.

Preferably, the code or symbol on the item of waste comprises a QR code.

Preferably, the code or symbol associated with the recycling reservoir comprises a code or symbol on the recycling reservoir. The code or symbol may comprise a QR code.

Alternatively, the code or symbol associated with the recycling reservoir may comprise a code that is provided wirelessly. In one embodiment, the code may be provided by Radio-frequency identification (RFID), Near Field Communication (NFC), wireless local-area network (WLAN) or Bluetooth.

Preferably, the portable computing device comprises a smartphone. The smartphone may be configured to provide details of a match to a remote computing device, where the smart contract is executed.

Preferably, location information is captured when the code or symbol of the item of waste and/or the recycling reservoir is scanned, and associated with the execution of the smart contract.

Preferably, the one or more tokens comprise cryptocurrency transferred to a wallet associated with the portable computing device.

In another form, the invention resides broadly in a waste recycling method comprising:
scanning, using a camera of a waste sorting system, a code or symbol of an item of waste, the code or symbol identifying a type of the item of waste;
moving, using the waste sorting system, the item of waste to a recycling reservoir associated with the type of the item of waste; and
executing, upon moving the item of waste to the recycling reservoir associated with the type of the item of waste, a smart contract, the smart contract allocating one or more tokens to an account associated with the waste sorting system.

Advantageously, the method incentivizes recycling by providing one or more tokens to an account when an item is moved to an appropriate recycling reservoir. As smart contracts are used, investment in the waste sorting system may be made with certainty.

Preferably, the smart contract is defined on a blockchain or distributed ledger.

Preferably, each type (class) of waste is associated with a different smart contract.

Preferably, the item of waste comprises a single use item, such as a plastic bottle or aluminium can.

Preferably, the code or symbol on the item of waste comprises a QR code.

Preferably, the one or more tokens comprise cryptocurrency transferred to a wallet associated with the waste sorting system.

Preferably, the waste sorting system is at least partly solar powered.

Preferably, the waste sorting system comprises a modular autonomous recycler, wherein multiple modular autonomous recyclers are used at different locations.

In yet another form, the invention resides broadly in a waste recycling system comprising:
a plurality of portable computing devices, each configured to:
   scan a code or symbol of an item of waste, the code or symbol identifying a type of the item of waste;
   scan a code or symbol associated with a recycling reservoir and a particular type of waste; and determine, a match between the type of the item of waste and the type of waste associated with the recycling reservoir; and
at least one remote server configured to:
   execute, upon determining the match, a smart contract, the smart contract allocating one or more tokens to an account associated with the portable computing device according to the match.

Preferably, the at least one remote server comprises a distributed network of computers.

In yet another form, the invention resides broadly in a waste recycling system comprising:
a camera configured to scan a code or symbol of an item of waste, the code or symbol identifying a type of the item of waste;
at least one actuator, configured to move the item of waste to a recycling reservoir associated with the type of the item of waste; and
at least one remote server configured to execute, upon moving the item of waste to the recycling reservoir associated with the type of the item of waste, a smart contract, the smart contract allocating one or more tokens to an account associated with the waste sorting system.

Preferably, the at least one remote server comprises a distributed network of computers.

The above waste recycling systems and methods may be combined to provide both user and automated sorting.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a recycling system, according to an embodiment of the present invention.

FIG. 2 illustrates a screenshot of a recycling application of the portable computing device of the system of FIG. 1, according to an embodiment of the present invention.

FIG. 3 illustrates a screenshot of a recycling screen of the recycling application of FIG. 2, according to an embodiment of the present invention.

FIG. 4 illustrates a screenshot of a wallet screen of the recycling application of FIG. 2, according to an embodiment of the present invention.

FIG. 5 illustrates a schematic of an autonomous recycling system, according to an embodiment of the present invention.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

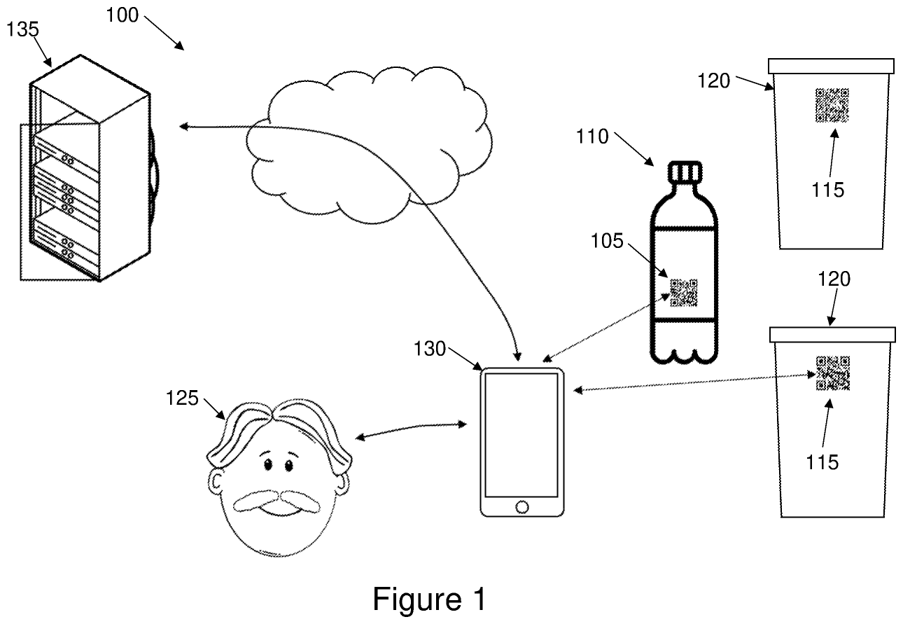

FIG. 1 illustrates a recycling system 100, according to an embodiment of the present invention. The recycling system 100 encourages users to recycle items, and particularly single use items such as bottles, cans and the like, and provides rewards for placing these items in an appropriate recycling reservoir.

The system 100 includes QR codes 105 on recyclable items 110, such as bottles, cans and the like, and corresponding QR codes 115 on recycling reservoirs 120 (e.g. bins). The system 100 includes a plurality of different classes of recycling reservoirs 120 for different classes of recyclable items 110, and the QR codes 105, 115 correspond to different recycling classes.

In use, a user 125 scans a QR code 105 of a recyclable item 110 using a portable computing device 130 associated with the user 125, scans a QR code 115 of a corresponding recycling reservoir 120, and places the recyclable item 110 in the corresponding recycling reservoir 120. The system 100 confirms a match between the class of the recyclable item 110 and the class of the recycling reservoir 120, to ensure that the recyclable item 110 is provided in a suitable reservoir.

The portable computing device 130, which may comprise a smartphone, then sends confirmation of the match to a remote server 135, upon which a smart contract is executed and a cryptocurrency token is allocated to the user as a reward, as outlined in further detail below. While a single remote server 135 is illustrated for the sake of clarity, this remote server 135 is representative of a network of computers, as outlined below.

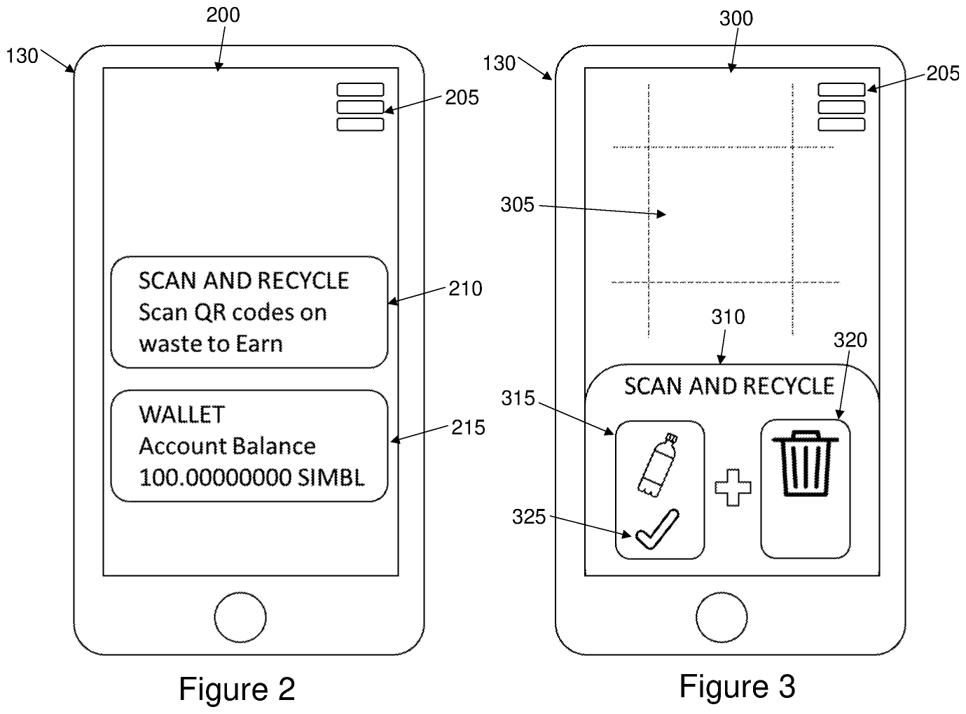

FIG. 2 illustrates a screenshot 200 of a recycling application of the portable computing device 130, according to an embodiment of the present invention.

The recycling application is associated with the user 125 through an account, and the user logs in to his or her account using a username and password, as is well understood in the space of software applications. As the account is associated with the user 125, any recycling actions performed by the user 125, and rewards associated therewith, may be automatically associated with the user 125.

The recycling application includes a menu button 205, together with a scan and recycle button 210, and a cryptocurrency wallet button 215.

When recycling, the user 125 selects the scan and recycle button 210, upon which a recycling screen is displayed.

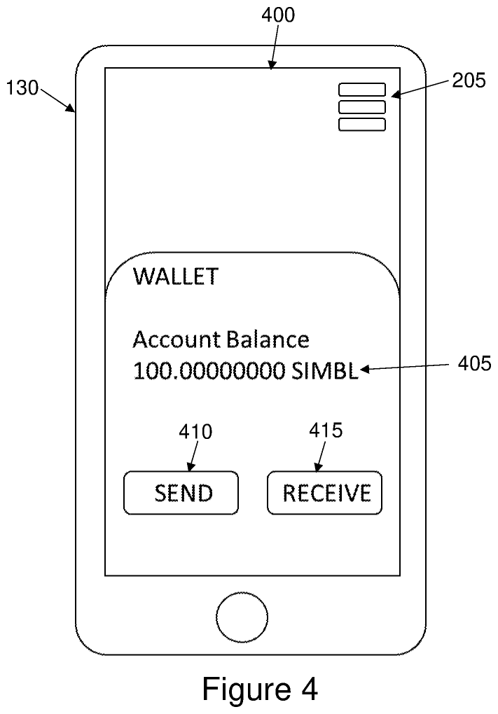

FIG. 3 illustrates a screenshot 300 of a recycling screen of the recycling application, according to an embodiment of the present invention.

The recycling screen includes a viewfinder element 305, on which image data from a camera of the portable computing device 130 is displayed, with a viewfinder grid overlaid thereon. This provides an intuitive user interface for the user 125 to appropriately position the portable computing device 130 relative to the QR code 105, 115 of the recyclable item 110 or recycling reservoir 120, to enable scanning thereof.

The user 125 may initially scan either the QR code 105 of the recyclable item 110 or the QR code 115 of the recycling reservoir 120, upon which the user will be prompted to scan the other of the QR code 105 of the recyclable item 110 or the QR code 115 of the recycling reservoir 120.

The recycling screen includes a scan progress item 310, comprising a recyclable item element 315 and a recycling reservoir element 320. The recyclable item element 315 and the recycling reservoir element 320 are provided with a visual indicator in the form of a tick 325 to indicate that the item has been properly scanned. In FIG. 3, the recyclable item element 315 includes a tick 325, but not the recycling reservoir element 320, indicating that the recyclable item has been scanned, but not the associated recycling reservoir.

When scanning the QR code 105 of the recyclable item 110 or the QR code 115 of the recycling reservoir 120, information about the recyclable item 110 or the recycling reservoir 120 may be provided to the user 125, e.g. displayed on the screen of the portable computing device 130. As an illustrative example, when scanning the recyclable item 110, information about the type of the recyclable item 110 (e.g. clear glass) may be provided to assist the user in choosing the appropriate recycling reservoir 120. Similarly, information regarding the environmental impact associated with recycling the item 110 may be provided, or any other suitable information.

When both the recyclable item 110 and recycling reservoir 120 are scanned, the recycling application confirms a match between the recycling reservoir 120 and recyclable item 110. If a match is not determined, a warning is issued to the user 125 indicating that an incorrect recycling reservoir 120 has been scanned, prompting the user 125 to identify a correct recycling reservoir and rescan the QR code 115 of the correct recycling reservoir 120, and dispose of the item 110 in the correct recycling reservoir 120.

Matching between recycling reservoir 120 and recyclable item 110 may be performed in a number of ways, including by using a lookup table and/or one or more rules.

Once both the recyclable item 110 and recycling reservoir 120 are scanned, and confirmed to be matching, the user is prompted to dispose of the item 110 in the recycling reservoir 120, and confirmation of the match (and recycling) is provided to the remote server 135, in association with the user's account.

In particular, the portable computing device 130 sends a message to the remote server 135, together with details of the user's account. This will generally be performed wirelessly including a cellular network or wireless local area network, as will be readily understood by the skilled addressee.

Upon receipt of the message, a smart contract is executed and a cryptocurrency token is allocated to the user 125 as a reward, to promote recycling of the item 110.

In addition to providing confirmation of the match and the user's details, the portable computing device 130 may provide other information to the remote server 135. As an illustrative example, the information may include location information, such as GPS coordinates from the portable computing device. Such configuration enables analysis of waste disposal locations, as they are used, to enable more efficient waste management.

Similarly, the QR codes 105, 115 may include information in addition to waste category, including waste origin details (e.g. manufacturer or brand), recycling reservoir details 120 (e.g. a unique identifier associated with the reservoir, or group of reservoirs), or any other suitable information. Such configuration enables more detailed data analysis to be performed, including detailing levels waste generated by waste producers, recycling levels, and recycling performed by the waste producers themselves.

This enables the system to easily generate data over what products are being recycled, and the general geographic location of where the products are being recycled, which is particularly useful for planning. This data may also contribute to triple bottom line reporting, and create a supply chain feedback loop for manufacturers.

While the above example illustrates matching of a recycling reservoir 120 and recyclable item 110, in other embodiments, a recycling reservoir may include multiple sub-reservoirs, whereby access to a sub-reservoir is provided upon scanning of a code on an item.

As an illustrative example, a smart bin may automatically open a correct sub-reservoir lid upon scanning of the item, thereby preventing the item from being incorrectly placed in a recycling bin.

The cryptocurrency token is provided to a wallet associated with the user, and the wallet is accessible using the cryptocurrency wallet button 215, mentioned above.

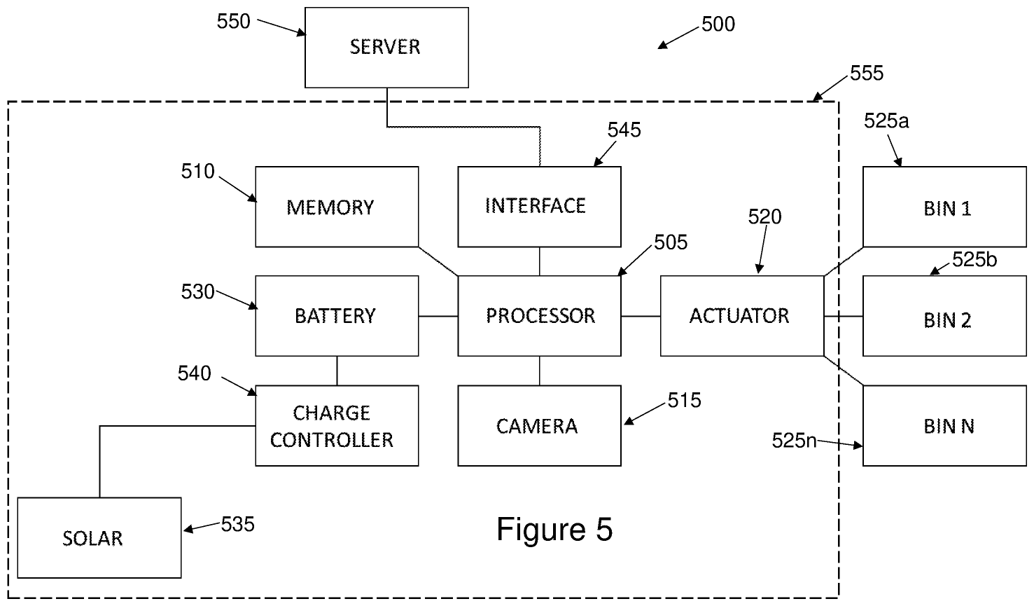

FIG. 4 illustrates a screenshot 400 of a wallet screen of the recycling application, according to an embodiment of the present invention.

The wallet screen provides an overview of the user's wallet, including account balance, and enables the user 125 to utilise the cryptocurrency in the wallet.

The wallet screen includes an account balance element 405, indicating a balance of the wallet, and send and receive buttons 410, 415, to enable the user 125 to send and receive cryptocurrency from and to the wallet.

Upon selection of the send button 410, to send cryptocurrency from the wallet, the user 125 is prompted to enter the address of the receiving wallet and the amount of cryptocurrency the user 125 would like to send. Upon confirmation, the cryptocurrency is sent to the receiving wallet.

Upon selection of the receive button 415, to receive cryptocurrency into the wallet, an address (public key) of the wallet is provided, and either sent to the sending party, or provided in a QR code to enable it to be shared with the sending party.

Such features enable the wallet to function independently of the recycling system, e.g. to purchase goods and services, and thus enables the user 125 to utilise the tokens that he or she has collected through recycling.

Finally, the menu button 205 enables the user 125 to manage his or her account, including passwords, contact details and the like, as well as settings of the application, as is common in relation to applications.

The application may include a wide range of other features, from messaging, to social media-like functionality. In particular, messaging functionality may enable enthusiastic recyclers to communicate and collaborate on recycling initiatives with each another. Similarly, the application may include voice calling and/or video calling functionality, to enable users to communicate by voice and/or video.

The application will preferably protect the identity and/or privacy of users in such communication, e.g. by hiding IP address and providing E2E (end-to-end) encryption.

While the above illustrates the application being used to scan the QR codes, the QR codes may include a link to the application, in case a user scans a QR code without the application installed. In such case, the QR code may comprise a combination of a link (URL) together with data, such that the link is used to link to the application when not installed, and provides data directly to the application when installed and scanned by the application.

In some situations, it is not practical for users 125 to sort recyclable items 110, and commingled waste recycling bins are instead used. These waste recycling bins must then be sorted to enable the items 110 therein to be recycled.

An autonomous recycler is provided in such case to assist in recycling such items, the autonomous recycler being rewarded for sorting the items much like users 125 are, using smart contracts, as outlined above. Such system promotes the creation and deployment of autonomous recyclers, as rewards may be used to fund such recyclers in a pre-defined manner.

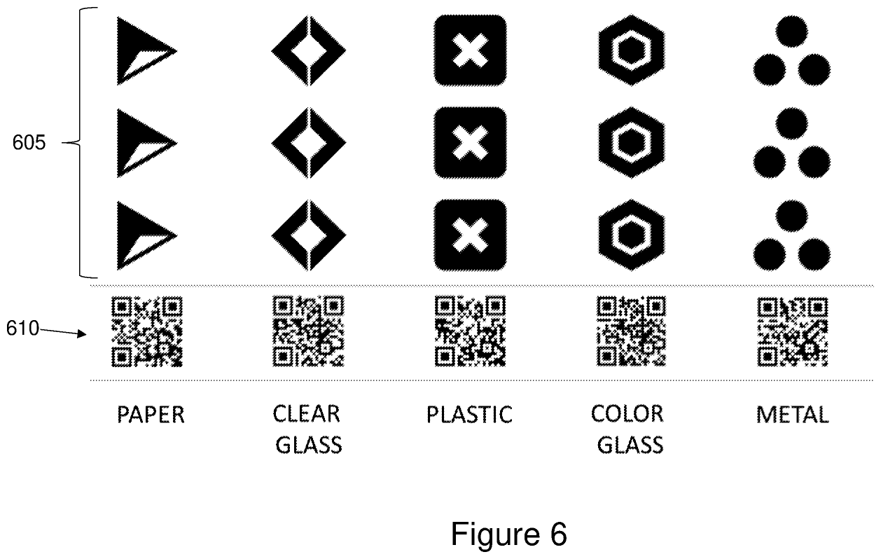

FIG. 5 illustrates a schematic of an autonomous recycling system 500, according to an embodiment of the present invention.

The autonomous recycling system 500 includes a processor 505, with a memory 510 coupled to the processor 505, for controlling various components and performing various functions of the system 500.

In particular, a camera 515 is coupled to the processor 505, which is configured to capture images of items of comingled waste, and identify a recycling class or category of the item (e.g. clear glass, aluminium, etc). This is primarily achieved by identifying QR codes on the items, the QR codes including identifiers of the recycling class or category of the item, but may be complemented with other identification mechanisms, including shape based mechanisms and/or artificial intelligence or machine learning.

Once the processor 505 has identified the recycling class or category of the item from the image or images from the camera 515, an actuator 520 is used to place the item into a bin 525 corresponding to the recycling class or category of the item.

The processor 505 and associated electrical components are powered by a battery 530, coupled to solar panels 535 by a charge controller 540. This ensures that the system 500 may operate in an efficient manner, and without power cost.

A data interface 545 is coupled to the processor, and is configured to communicate with a remote server 550, as outlined below.

The processor 505, memory 510, camera 515, actuator 520, battery 530, solar panels 535 and charge controller 540, together form a modular autonomous recycler 555. While only a single modular autonomous recycler 555 is illustrated, the skilled addressee will readily appreciate that a number of modular autonomous recyclers 555 will be used across various geographical locations, each coupled to the remote server 550.

For each categorisation and sorting action performed by the modular autonomous recycler 555, the processor 505 generates a confirmation message which is sent to the remote server 550. The remote server 550 may be similar or identical to the remote server 135 of FIG. 1, and be illustrative of a network of computers that executes smart contracts to provide cryptocurrency rewards to an account associated with the modular autonomous recycler 555.

This promotes the investment into modular autonomous recyclers 555, as a well-defined return on investment may be provided, as outlined in a smart contract.

While the above drawings illustrate a single remote server, the skilled addressee will readily appreciate that a distributed network of servers is provided, and preferably in a non-centralised manner. Further details of such distributed network is described below.

In other embodiments, the batteries 530 are removable and charged separately to the modular autonomous recyclers 555. In such case, multiple batteries may be used and interchanged. Alternatively again, the system may be configured to operate during daylight and when solar is generating power, thereby alleviating the need for (or reducing the requirements of) the batteries 530.

While not illustrated, the modular autonomous recyclers 555 are waterproof and adapted to be cleaned, e.g. with pressurised water from a high pressure washer. This is particularly important given that the recyclers 555 will be exposed to the elements and waste contaminants.

In addition to utilising cameras 515, the recyclers 555 may include various sensors that may also be used to identify waste items.

In some embodiments, the recyclers 555 may be configured to identify hazards, such as persons or animals in proximity to the actuators (or a work zone). The recyclers 555 may then automatically stop until the zone is clear.

In some embodiments, the modular autonomous recyclers 555 are able to move between recycling bins and take waste with them into a desired bin. In such case, the modular autonomous recyclers 555 may even comprise robots able to climb in and out of bins, and the actuators may comprise claws or similar devices adapted to hold the waste items during transport.

In other embodiments, the modular autonomous recyclers 555 may be statically positioned relative to the bins, and include conveyors or similar to transport items to different bins.

Various modular autonomous recycler (robot) designs may be provided in an open source manner, enabling anyone to create a robot. This enables individuals and companies to easily create a robot, by downloading plans and software, and building a robot according to the plans.

The robot may be used in another company. Such situation is feasible as third parties (e.g. the creator of the robot) are able to invest in recycling infrastructure (e.g. the robot) to assist in recycling, while being provided a return on their investment through a smart contract.

In some embodiments, the robot may be provided to the company at no cost to that company. This is particularly relevant for companies that capture waste generated elsewhere, e.g. bars and restaurants. In other embodiments, the robot may be provided to the company at a cost to that company. This is particularly relevant for companies generating their own recyclable waste, or those required to process a certain amount of recycling.

The modular autonomous recycler 555 may be used in any suitable location, but is particularly suited to locations where individuals place items in co-mingled bins, such as in restaurants and shopping centres. Most waste in these locations is co-mingled requiring sorting, and has traditionally been done poorly or ineffectively and at a cost to tax-payers and the environment.

As outlined above, the system 100 includes QR codes 105 on recyclable items 110, such that the QR codes 105 correspond to different recycling classes. This may be achieved in a variety of ways, including a recycling class field encoded in data of the QR code. This enables different information to be stored in QR codes in addition to a recycling class information.

In one embodiment, the QR code may include data comprising an identifier of the product. The QR code may include data relating to the product, such as manufacturing location, manufacturing date, expiry or best before date, batch number, or the like. Such data may be explicitly encoded in the QR code, or implicitly encoded in the QR code, e.g. with reference to an online lookup table or the like.

While the above embodiments describe QR codes, in other embodiments, other types of symbols or machine readable codes may be used.

FIG. 6 illustrates an exemplary symbol arrangement, including symbols 605 and QR codes 610 which may be used to identify waste categories.

The symbols 605 are both aesthetically pleasing and easily identifiable.

In other embodiments, the symbols 605 may comprise an aesthetically pleasing and easily identifiable portion, and an encoded (machine readable) portion, encoding data relating to the product.

In addition to scanning items when recycling, in some embodiments the user may scan items at time of purchase or acquisition. Such configuration enables the system to not only assist in recycling of the item, but also issue alerts and provide information about the item itself.

In one embodiment, the system may be configured to issue alerts relating to the item. For example, the system may be configured to issue an alert prior to a use by or best before date is reached, if the item is not marked as recycled. Similarly, the system may be configured to issue an alert relating to a product recall associated with the item.

In some embodiments, and in the case of product recalls, the system may enable a wide range of attributes to be entered or selected that meet the criteria for items to be recalled, wherein alerts are only issued if the criteria are met. The attributes may define multiple batches, use by or best before dates, and potential in combination with retail information (e.g. purchase time). As an illustrative example, if the supply chain for frozen items has failed for a specific supermarket and on a specific day, a recall need not issue for all such products, but only batches sold after the incident, and for batch numbers made before the incident, thereby enabling the waste/loss to be reduced.

In some embodiments, in addition to assisting users, the information encoded in the QR codes may be used for marketing or research purposes, and may identify behavioural patterns or the like. Such data may be used in a variety of ways, as will be readily appreciated by the skilled addressee.

In some embodiments, the system 100 includes a POS scanner, configured to scan the QR code (or other type of code) of products at the time of purchase, and generate a purchase summary.

The purchase summary may be identified by a further QR code (or other type of code), e.g. on a payment receipt associated with the purchase. In such case, the user may simply scan the further QR code, rather than the individual codes for each item. This is particularly convenient in the case of product recalls and best before/use by reminders, as it provides a very simple way for adding details of potentially many items.

In some cases, the further QR code may be associated with an account of the user, such as a rewards account, enabling the user to scan the code a single time for both rewards and to enter the items.

The skilled addressee will readily appreciate that the items may be managed in a number of ways, but in some embodiments a register of items is managed for the user, where products are removed from the register once recycled. This enables management of use by/best before dates, as well as a good oversight of items available. These items may also be manually reconciled or removed in the case of error, or when recycling has been performed outside of the system.

Similarly, the skilled addressee will readily appreciate that users may configure the system, e.g. using an application on the smartphone. As an illustrative example, users may select if and when they receive certain types of alerts, and configure how these alerts are received.

As outlined above, cryptocurrency is provided as a reward, by executing smart contracts. A smart contract may be provided for each waste type, and can be expanded and changed on the blockchain to include new recycling classes as the recycling process evolves.

Preferably, the blockchain network used for this purpose is a decentralised, secure, high speed, globally distributed computing network with no transaction fees, making it suited to low value high volume transactions (execution of smart contracts) of this type. The EOS blockchain network is particularly suitable for this purpose due to its scalability and because the executed smart contracts have an extremely low transaction value.

The blockchain network includes a plurality of block producers (nodes), comprising highly secure computers in different physical locations (i.e. distributed) that have the same software installed. The block producers have three main purposes, namely to create blocks, provide consensus for blocks, and to store smart contracts.

The network creates blocks every 0.5 seconds for the blockchain. The network processes and records the recycling transactions from both the systems 100 and 500 above, and adds these to a block. Each block contains the amount of recycling transactions that are sent to the network in a 0.5 second period. The network also records the exchange of tokens between participants.

When a block is created by a node, it is instantly sent to all the other nodes in the network. Other nodes may then validate the blocks of transactions.

The network further stores the smart contracts or the fixed rules that allow recycling transactions to occur on the network. The accounts or wallets for the individuals and modular autonomous recycler are also stored.

The block producers are associated with companies that are listed on stock exchanges and have passed Know Your Customer (KYC) verification. As such, the system incorporates a new form of Byzantine Fault Tolerance referred to as Delegated Proof of Ethical Stake (DPoES), where companies that wish to be block producers have to be listed companies on a stock exchange, evidence their commitment to global recycling, and utilise the QR codes (or corresponding symbols, as outlined above) on their products. Service providers may also become block producers by updating their mission statements and commitment to shareholders to advocate for the use of products that incorporate such QR codes (or corresponding symbols) on their products.

The network is configured by its users, and the network's computing is managed by companies that have passed KYC to establish their Proof of Ethical Stake. While block producers not falling within this criteria may be initially added, such block producers will perform a temporary role until the network reaches scale that has a sufficient number of block producers to operate independently.

The network is comprised of a core network (the innermost layer), accessible by block producers only, an access network (rules and smart contracts) and a consumer network that is accessed by users.

Removal of unethical or byzantine actors will be the responsibility of the block producing nodes that run the network.

The lack of central control of the core and access network, and the lack of voting ensures that no single party or collaboration of parties can change the waste and recycling purpose of the network. The network purpose is locked. Nodes cannot alter any of the deployed smart contracts. Only the users of the network can configure how they interact with the network through the various deployed smart contracts running on the nodes.

The security of the network is strong as block producers have little or no ability to manipulate the state of the network. A byzantine event would require collusive corporate fraud on a massive scale, which would result in cartel legal liability for the listed companies, and be damaging to their share price and reputation with shareholders. This is significantly different to most public blockchain deployments which tend to reward block producers with tokens which can create token concentration and collusion risks.

In some jurisdictions, it may become a requirement that waste producers pay to recycle the waste that they produce. The systems described herein enable this to happen through the purchase of tokens to pay for recycling. In some embodiments, an initial batch of tokens may be provided to incentivise early adoption. After the initial batch of tokens runs out, waste producers may be required to pay for recycling by purchasing tokens and adding them to a pool of tokens for recyclers.

The price of tokens may be pegged to another currency, such as fiat (e.g. USD) or cryptocurrency (e.g. BTC). Such configuration may be beneficial in reducing fluctuation in the price of tokens, which could impact the economic viability of waste management.

In addition to providing the features described above, the system may perform analysis to identify and flag potential fraudulent recycling data for investigation. As an illustrative example, if a spike in recycling occurs that does not correlate to the amount of product (as waste) that has been put into the retail supply chain, an alert may issue. Manufacturers of fast moving consumer goods (FMCG) will thus be able to detect if the number of products being recycled is higher than their manufacturing rates and expected consumption rates, and investigate.

Similarly, manufacturers will be better equipped to target counterfeit manufacturers by understanding which markets the fraudulent manufacturers are targeting. The entry of counterfeit products into a market is a danger to consumers, and identifying such products may have various public safety benefits.

While the above description relates to a connected system, with connectivity to a remote server (representing a blockchain network), in other embodiments, the systems may be configured to operate at least partly offline. In such case, the robotic recycler may load contracts offline, i.e. capture and pool smart contracts and store them offline. These may be transferred to a connected device, or periodically uploaded, upon which the transactions are processed.

The above description makes reference to recycling. However, in the context of these systems, recycling does not refer to the actual transformation of the item into a new item, but instead to the sorting component of recycling, namely providing items into reservoirs for transformation into other items.

Similarly, while the above description makes reference to receiving cryptocurrency as a reward, in other embodiments the system may be utilised without allocating cryptocurrency as a reward. This is relevant for government agencies, that may wish to recycle items without incentive, or corporations forced to recycle a certain amount of items. In such case, the system may still document a number of recycled transactions, while providing transparency to the recycling efforts of the company.

While the above screens are illustrated in English, the skilled addressee will readily appreciate that different languages may be used in different locations and/or depending on user preferences.

Advantageously, the methods and systems incentivize recycling by providing one or more tokens to an account when an item is matched to or moved into an appropriate recycling reservoir. As smart contracts are used, commitment is provided prior to the recycling taking place.

The systems and methods provide a means for companies to work with governments and people to manage waste or recycling, and pay for it. In particular, the companies may essentially outsource management of their waste recycling/sorting, by paying tokens which are given to those sorting the waste.

Embodiments of the invention are simple to deploy, as a QR code or symbol may be incorporated on product packaging at little to no extra cost. In some embodiments, it may be printed as part of a label at no additional cost. Similarly, QR codes or symbols may be incorporated onto recycling bins at little cost.

The systems and methods enables manufacturers to be accountable for the waste that they produce, as it enables transparency around what waste is recycled and where, as well as the contribution by the manufacturer.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A waste recycling method configured to provide tokenized rewards for placing items of waste into appropriate recycling reservoirs, the method comprising:
scanning, using a portable computing device, a machine readable code or symbol of an item of waste, the code or symbol identifying a type of the item of waste;
scanning, using the portable computing device, a machine readable code or symbol associated with a recycling reservoir and a particular type of waste;
determining a match between the type of the item of waste and the type of waste associated with the recycling reservoir; and
executing, upon determining the match, a smart contract, the smart contract allocating one or more tokens to an account associated with the portable computing device according to the match as a reward for placing the item of waste into the recycling reservoir.

2. The method of claim 1, wherein the smart contract is defined on a blockchain or distributed ledger.

3. The method of claim 1, wherein each type (class) of waste is associated with a different smart contract.

4. The method of claim 1, wherein the item of waste comprises a single use item, such as a plastic bottle or aluminium can.

5. The method of claim 1, wherein the code or symbol on the item of waste is scanned using a camera of the portable computing device.

6. The method of claim 1, wherein the code or symbol on the item of waste comprises a QR code and the code or symbol on the recycling reservoir comprises a QR code.

7. The method of claim 1, wherein the portable computing device comprises a smartphone.

8. The method of claim 7, wherein the smartphone is configured to provide details of a match to a remote computing device, where the smart contract is executed.

9. The method of claim 1, wherein location information is captured when the code or symbol of the item of waste and/or the recycling reservoir is scanned, and associated with the execution of the smart contract.

10. The method of claim 1, wherein the one or more tokens comprise cryptocurrency transferred to a wallet associated with the portable computing device.

11. The method of claim 1, wherein the smart contract is executed remotely to the portable computing device.

12. The method of claim 1, further comprising:
determining that the machine readable code or symbol of the item of waste and the machine readable code or symbol associated with a recycling reservoir are scanned with a predefined time limit, and
wherein the smart contract is executed further upon determining that the codes are scanned within the predefined time limit.

13. The method of claim 1, wherein the code or symbol of the item of waste is further configured to encode data relating to a product associated with the item of waste, such as manufacturing date, expiry or best before date or batch number.

14. The method of claim 1, further comprising: issuing one or more alerts to the user according to the data relating to the product.

15. The method of claim 1, further comprising:
scanning, by a point of sale device, a plurality of machine readable codes or symbols of a plurality of items of waste; and
generating a compound code or symbol relating to the plurality of machine readable codes or symbols, for scanning by the portable computing device.

16. The method of claim 1, wherein the recycling reservoir includes multiple sub-reservoirs, wherein access to a sub-reservoir is provided upon scanning of a code on an item.

17. The method of claim 1, further comprising
scanning, using a camera of a waste sorting system, a code or symbol of another item of waste, the code or symbol identifying the type of the other item of waste;
moving, using the waste sorting system, the other item of waste to a recycling reservoir associated with the type of the other item of waste; and
executing, upon moving the item of waste to the recycling reservoir associated with the type of the item of waste, a further smart contract, the further smart contract allocating one or more tokens to an account associated with the waste sorting system.

18. The method of claim 17, wherein multiple waste sorting systems are used at different locations.

19. A waste recycling system comprising:
a plurality of portable computing devices, each configured to:
scan a code or symbol of an item of waste, the code or symbol identifying a type of the item of waste;
scan a code or symbol associated with a recycling reservoir and a particular type of waste; and
determine, a match between the type of the item of waste and the type of waste associated with the recycling reservoir; and
at least one remote server configured to:
execute, upon determining the match, a smart contract, the smart contract allocating one or more tokens to an account associated with the portable computing device according to the match.

20. The system of claim 19, wherein the at least one remote server comprises a distributed network of computers.
